(19) United States
(12) Patent Application Publication
(10) Pub. No.: US 2007/0084369 A1
(43) Pub. Date: Apr. 19, 2007

(54) Flexographic printing plate and process for production thereof

(75) Inventors: Kazuhisa Kodama, Yokkaichi-shi (JP); Chikara Isobe, Yokkaichi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR Corporation, Tokyo (JP)

(21) Appl. No.: 11/526,766

(22) Filed: Sep. 26, 2006

(30) Foreign Application Priority Data
Sep. 26, 2005 (JP) 2005-278475

(51) Int. Cl. B41C 3/08

(52) U.S. Cl. 101/401.1

(57) ABSTRACT

A flexographic printing plate, which comprises a plate formed in a form of sheet from a composition 100 parts by mass of (A1) a thermoplastic elastomer and 0.1 to 50 parts by mass of (B) silica particles, and has an intended printing pattern formed on at least one side which is a side to be subjected to laser processing of the plate formed in a form of sheet for laser processing by subjecting the at least one side to laser processing for engraving. The flexographic printing plate has good flexibility but is not sticky at the processed surface, is superior in transparency, gives neither offensive odor nor flaming during laser processing, at an excellent engraving precision, can be produced easily and has a sufficient engraving depth.

### TECHNICAL FIELD OF THE INVENTION

The present invention relates to a flexographic printing plate and a method for production thereof.

### DESCRIPTION OF RELATED ART

For the formation of protruded and/or recessed portions on the surface of a polymer material to produce a printing plate, there is generally used a method of engraving a vulcanized rubber sheet with a graver. In this engraving method using a graver, however, a high-level hand-engraving technique is required. Therefore, experience skill is needed and, moreover, there is a limit in engraving fine and complicated letters or figures thereon. In producing a flexographic printing plate, it is further necessary to attach various parts produced by hand engraving, onto a resin sheet (e.g. PET) at exact registration, using an adhesive. There is a problem that it requires labor and time.

Meanwhile, there is a method of crosslinking and curing (or softening) a photosensitive resin with an ultraviolet radiation and then removing the uncured portions for development, prior to produce a printing plate. In this method, fine and complicated letters or figures can be engraved easily; however, since a large amount of an organic solvent is required during development, it causes the problem that the working environment becomes worse and the natural environment is polluted. In recent years, there has been developed a method of applying a laser beam emitted from a laser processing machine, to a printing material to engrave an intended shape, etc. thereon. However, when laser processing is conducted for a conventional printing material made of a rubber material, offensive odor caused by rubber burning is generated, it causes the problem that working environment or surrounding environment is polluted.

A silicone rubber-based material has been developed as a substitute for the rubber material constituting a conventional printing material. This silicone rubber-based material, as compared with the conventional rubber material, has an advantage of reducing odor during laser processing. However, the silicone rubber-based material has various problems; for example, it may flame from the surface of printing material during working, it is inferior in reproducibility of fine and complicated pattern, and stickiness remains on the surface of printing material after laser processing and a printing ink is repelled. The silicone rubber-based material further has a problem in that a long time is needed for engraving.

As a conventional technique for dissolving the above-mentioned problems, there are disclosed a polymer material for laser processing, obtained by crosslinking of ethylene-based polymer or copolymer, and a laminate for laser processing applying the polymer or copolymer (see, for example, Patent Literatures 1 and 2). There is also disclosed a flexographic printing element containing a predetermined amount of a syndiotactic 1,2-polybutadiene, which can be made into a printing plate by laser processing (see, for example, Patent Literature 3).

Even with the polymer materials for laser processing etc., as disclosed in the above Patent Literatures, however, it has been difficult to completely suppress the generation of offensive odor or flaming during laser processing, which has been a problem heretofore. Further, with these polymer materials, there are cases that the processed surface thereof becomes sticky and thereby the viscous substance remaining on the surface is difficult to remove by washing, or cases that the edge portions are melt by the heat of laser processing, making the ability of pattern formation insufficient etc. Thus, further improvement is necessary.

Patent Literature 1: JP-A-2002-3665

Patent Literature 2: JP-A-2002-103539

Patent Literature 3: JP-T-2004-523401

### SUMMARY OF THE INVENTION

The present invention has been made in view of the above-mentioned problems of prior art. The present invention aims at providing a flexographic printing plate which has good flexibility but is not sticky at the processed surface, is superior in transparency, gives neither offensive odor nor flaming during laser processing, can be produced easily at an excellent engraving precision, and has a sufficient engraving depth; and a method for producing such a flexographic printing plate.

According to the present invention there are provided a flexographic printing plate and a method for producing it, both described below.

[1] A flexographic printing plate,

which comprises a plate formed in a form of sheet from a composition 100 parts by mass of (A1) a thermoplastic elastomer and 0.1 to 50 parts by mass of (B) silica particles, and has an intended printing pattern formed on at least one side which is a side to be subjected to laser processing of the plate formed in a form of sheet for laser processing by subjecting the at least one side to laser processing for engraving.

[2] A flexographic printing plate according to [1], wherein the composition for laser processing further contains 100 parts by mass or less of (A2) a non-crosslinked rubber relative to 100 parts by mass of the thermoplastic elastomer (A1).

[3] A flexographic printing plate according to [2], wherein the non-crosslinked rubber (A2) is a liquid butadiene rubber.

[4] A flexographic printing plate according to [1], wherein the thermoplastic elastomer (A1) is at least one selected from the group consisting of a syndiotactic 1,2-polybutadiene, a hydrogenated diene-based copolymer and a styrene-based thermoplastic elastomer.

[5] A flexographic printing plate according to [4], wherein, when the thermoplastic elastomer (A1) is a syndiotactic 1,2-polybutadiene and a styrene-based thermoplastic elastomer, the mass ratio of the syndiotactic 1,2-polybutadiene and the styrene-based thermoplastic elastomer is 80:20 to 20:80.

[6] A flexographic printing plate according to [1], wherein the silica particles (B) are anhydrous silica particles.

[7] A flexographic printing plate according to [1], wherein the silica particles (B) have an average primary particle diameter of 0.005 μm or more but less than 0.1 μm.

[8] A flexographic printing plate according to [1], wherein the sheet for laser processing has been subjected to a crosslinking treatment.

[9] A flexographic printing plate according to [8], wherein the sheet for laser processing, when extracted with toluene of 60° C. for 3 hours, shows a gel proportion of 80 mass % or more.

[10] A flexographic printing plate according to [1], wherein the sheet for laser processing has a sheet-shaped base material layer laminated on the side other than the laser-processed side.

[11] A method for producing a flexographic printing plate,

which comprises a plate formed in a form of sheet from a composition 100 parts by mass of (A1) a thermoplastic elastomer and 0.1 to 50 parts by mass of (B) silica particles, and has an intended printing pattern formed on at least one side which is a side to be subjected to laser processing of the plate formed in a form of sheet for laser processing by subjecting the at least one side to laser processing for engraving.

[12] A method for producing a flexographic printing plate according to [11], wherein the composition for laser processing further contains 100 parts by mass or less of (A2) a non-crosslinked rubber relative to 100 parts by mass of the thermoplastic elastomer (A1).

[13] A method for producing a flexographic printing plate according to [12], wherein the non-crosslinked rubber (A2) is a liquid butadiene rubber.

[14] A method for producing a flexographic printing plate according to [11], wherein the thermoplastic elastomer (A1) is at least one selected from the group consisting of a syndiotactic 1,2-polybutadiene, a hydrogenated diene-based copolymer and a styrene-based thermoplastic elastomer.

[15] A method for producing a flexographic printing plate according to [14], wherein, when the thermoplastic elastomer (A1) is a syndiotactic 1,2-polybutadiene and a styrene-based thermoplastic elastomer, the mass ratio of the syndiotactic 1,2-polybutadiene and the styrene-based thermoplastic elastomer is 80:20 to 20:80.

[16] A method for producing a flexographic printing plate according to [11], wherein the silica particles (B) are anhydrous silica particles.

[17] A method for producing a flexographic printing plate according to [11], wherein the silica particles (B) have an average primary particle diameter of 0.005 μm or more but less than 0.1 μm.

[18] A method for producing a flexographic printing plate according to [11], wherein the sheet for laser processing has been subjected to a crosslinking treatment.

[19] A method for producing a flexographic printing plate according to [18], wherein the sheet for laser processing, when extracted with toluene of 60° C. for 3 hours, shows a gel proportion of 80 mass % or more.

[20] A method for producing a flexographic printing plate according to [11], wherein the sheet for laser processing has a sheet-shaped base material layer laminated on the side other than the to-be-processed side.

The flexographic printing plate of the present invention has good flexibility but is not sticky at the processed surface, is superior in transparency, gives neither offensive odor nor flaming during laser processing, can be produced easily at an excellent engraving precision, and has a sufficient engraving depth.

According to the method of the present invention for producing a flexographic printing plate, a flexographic printing plate which has good transparency but is not sticky at the processed surface, is superior in transparency and has a printing pattern with superior engraving precision and sufficient engraving depth, can be produced easily without giving any offensive odor or flaming during laser processing.

### BRIEF EXPLANATION OF THE DRAWINGS

FIG. 1 is a microphotograph of the flexographic printing plate of Example 1.

FIG. 2 is a microphotograph of the flexographic printing plate of Example 1.

FIG. 3 is a microphotograph of the flexographic printing plate of Comparative Example 1.

### DESCRIPTION OF PREFERRED EMBODIMENTS

The best embodiment of the present invention is described below. However, the present invention is in no way restricted to the following embodiment and any modified embodiment, any improved embodiment or the like made appropriately thereon based on the ordinary knowledge of those skilled in the art, as long as there is no deviation from the gist of the present invention.

An embodiment of the flexographic printing plate of the present invention, which comprises a plate formed in a form of sheet from a composition 100 parts by mass of (A1) a thermoplastic elastomer and 0.1 to 50 parts by mass of (B) silica particles, and has an intended printing pattern formed on at least one side which is a side to be subjected to laser processing of the plate formed in a form of sheet for laser processing by subjecting the at least one side to laser processing for engraving.

(A1) Thermoplastic Elastomer

The composition for laser processing, which is a raw material for the sheet for laser processing, to be used for production of the flexographic printing plate of the present embodiment, contains (A1) a thermoplastic elastomer. As a specific example, there can be mentioned at least one selected from the group consisting of (A1-1) a syndiotactic 1,2-polybutadiene, (A1-2) a hydrogenated, diene-based copolymer and (A1-3) a styrene-based thermoplastic elastomer.

(A1-1) Syndiotactic 1,2-Polybutadiene

A syndiotactic 1,2-polybutadiene is preferably used as the thermoplastic elastomer (A1) contained in the composition for laser processing. As the syndiotactic 1,2-polybutadiene, there is preferred, for example, one having a crystallinity of 5% or more and more preferred one having a crystallinity of 10 to 40%. There is also preferred one having a melting point of 50 to 150° C. and more preferred one having a melting point of 60 to 140° C. When the crystallinity and melting point of the syndiotactic 1,2-polybutadiene are in the above ranges, there can be obtained a flexographic printing plate well-balanced between dynamic strengths (e.g. tensile strength and tear strength) and flexibility.

In the syndiotactic 1,2-polybutadiene, the 1,2-bond content in the bound butadiene unit is preferably 70% or more, more preferably 80% or more, particularly preferably 90% or more in order to exhibit good properties as a thermoplastic elastomer. The syndiotactic 1,2-polybutadiene can be produced, for example, by polymerizing butadiene in the presence of a catalyst containing a cobalt compound and an aluminoxane; however, the method for production thereof is not restricted thereto.

The syndiotactic 1,2-polybutadiene may be obtained by copolymerizing a small amount of a conjugated diene other than butadiene. As the conjugated diene other than butadiene, there can be mentioned 1,3-pentadiene, a 1,3-butadiene derivative substituted with higher alkyl group, a 2-alkyl-substituted-1,3-butadiene, etc. As the 1,3-butadiene derivative substituted with higher alkyl group, there can be mentioned 1-pentyl-1,3-butadiene, 1-hexyl-1,3-butadiene, 1-heptyl-1,3-butadiene, 1-octyl-1,3-butadiene, etc.

As the 2-alkyl-substituted-1,3-butadiene, there can be mentioned 2-methyl-1,3-butadiene (isoprene), 2-ethyl-1,3-butadiene, 2-propyl-1,3-butadiene, 2-isopropyl-1,3-butadiene, 2-butyl-1,3-butadiene, 2-isobutyl-1,3-butadiene, 2-amyl-1,3-butadiene, 2-isoamyl-1,3-butadiene, 2-hexyl-1,3-butadiene, 2-cyclohexyl-1,3-butadiene, 2-isohexyl-1,3-butadiene, 2-heptyl-1,3-butadiene, 2-isohepthyl-1,3-butadiene, 2-octyl-1,3-butadiene, 2-isooctyl-1,3-butadiene, etc. Of these conjugated dienes, isoprene and 1,3-pentanediene can be mentioned as preferred conjugated dienes to be copolymerized with butadiene. The content of butadiene in the monomers used in polymerization is preferably 50 mol % or more, more preferably 70 mol % or more.

As described above, the syndiotactic 1,2-polybutadiene can be obtained, for example, by polymerizing butadiene in the presence of a catalyst containing a cobalt compound and an aluminoxane. As the cobalt compound, there can be preferably mentioned a cobalt salt of an organic acid having at least 4 carbon atoms. As specific examples of the cobalt salt of organic acid, there can be mentioned butyric acid salt, hexanoic acid salt, heptylic acid salt, octylic acid salt (e.g. 2-ethyl-hexylic acid salt), higher fatty acid salt (e.g. decanoic acid salt, stearic acid salt, oleic acid salt or erucic acid salt), benzoic acid salt, alkyl-, aralkyl- or allyl-substituted benzoic acid salt (e.g. toluic acid salt, xylylic acid salt or ethylbenzoic acid salt), naphthoic acid salt, and alkyl-, aralkyl- or allyl-substituted naphthoic acid salt. Of these, preferred are octylic acid salt (e.g. 2-ethylhexylic acid salt), stearic acid salt and benzoic acid salt because they are highly soluble in hydrocarbon solvents.

As the aluminoxane, there can be mentioned, for example, those represented by the following general formula (1) or (2).

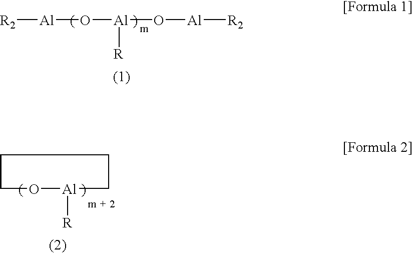

In the above general formulas (1) and (2), R is a hydrocarbon group such as methyl group, ethyl group, propyl group, butyl group or the like. Of them, methyl group or ethyl group is preferred and methyl group is more preferred. m is an integer of 2 or more, preferably an integer of 5 or more, more preferably an integer of 10 to 100. As specific examples of the aluminoxane, there can be mentioned methylaluminoxane, ethylaluminoxane, propylaluminoxane and butylaluminoxane etc. Methylaluminoxane is preferred particularly.

Particularly preferably, the polymerization catalyst contains a phosphine compound, in addition to the cobalt compound and the aluminoxane. The phosphine compound is a component which is effective for activation of the polymerization catalyst and control of vinyl bond configuration and crystallinity. As a preferred example, there can be mentioned an organic phosphorus compound represented by the following general formula (3).
P(Ar)ₙ(R′)₃₋ₙ (3)

In the above general formula (3), Ar is a group represented by the following general formula (4); R′ is a cycloalkyl group or an alkyl-substituted cycloalkyl group; and n is an integer of 0 to 3.

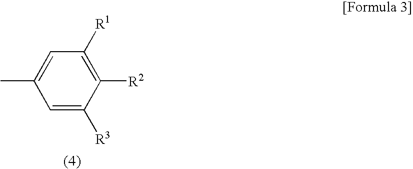

In the above general formula (4), R¹, R² and R³ may be the same or different and are a hydrogen atom, an alkyl group whose carbon atoms are preferably 1 to 6, a halogen atom, an alkoxy group whose carbon atoms are preferably 1 to 6, or an aryl group whose carbon atoms are preferably 6 to 12.

As specific examples of the phosphine compound represented by the general formula (3), there can be mentioned tri(3-methylphenyl)phosphine, tri(3-ethylphenyl)phosphine, tri(3,5-dimethylphenyl)phosphine, tri(3,4-dimethylphenyl)phosphine, tri(3-isopropylphenyl)phosphine, tri(3-tert-butylphenyl)phosphine, tri(3,5-diethylphenyl)phosphine, tri(3-methyl-5-ethylphenyl)phosphine, tri(3-phenylphenyl)phosphine, tri(3,4,5-trimethylphenyl)phosphine, tri(4-methoxy-3,5-dimethylphenyl)phosphine, tri(4-methoxy-3,5-diethylphenyl)phosphine, tri(4-butoxy-3,5-dibutylphenyl)phosphine, tri(p-methoxyphenyl)phosphine, tricyclohexylphosphine, dicyclohexylphenylphosphine, tribenzylphosphine, tri(4-methylphenyl)phosphine and tri(4-ethylphenyl)phosphine etc. Of these, there can be mentioned particularly preferably triphenylphosphine, tri(3-methylphenyl)phosphine, tri(4-methoxy-3,5-dimethylphenyl)phosphine, etc.

As the cobalt compound, there can also be used a compound represented by the following general formula (5).

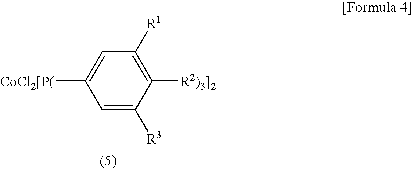

The cobalt compound represented by the general formula (5) is a complex wherein a phosphine compound of general formula (3) of n=3 coordinates as a ligand to cobalt chloride. This cobalt compound may be a synthesized product or may be used in such a manner that the cobalt chloride and the phosphine compound are contacted with each other in the polymerization system for production of polybutadiene. By selecting the phosphine compound in the complex, the amount of 1,2-bond and crystallinity of the syndiotactic 1,2-polybutadiene obtained can be controlled.

As specific examples of the cobalt compound represented by the general formula (5), there can be mentioned cobalt bis(triphenylphosphine) dichloride, cobalt bis[tris(3-methylphenylphosphine)]dichloride, cobalt bis[tris(3-ethylphenylphosphine)], cobalt bis[tris(4-methylphenylphosphine)]dichloride, cobalt bis[tris(3,5-dimethylphenylphosphine)]dichloride, cobalt bis[tris(3,4-dimethylphenylphosphine)]dichloride, cobalt bis[tris(3-isopropylphenylphosphine)]dichloride, cobalt bis[tris(3-tert-butylphenylphosphine)]dichloride, cobalt bis[tris(3,5-diethylphenylphosphine)]dichloride, cobalt bis[tris(3-methyl-5-ethylphenylphonine)]dichloride, cobalt bis[tris(3-phenylphenylphosphine)]dichloride, cobalt bis[tris(3,4,5-trimethylphenylphosphine)]dichloride, cobalt bis[tris(4-methoxy-3,5-dimethylphenylphosphine)]dichloride, cobalt bis[tris(4-ethoxy-3,5-diethylphenylphosphine)]dichloride, cobalt bis[tris(4-butoxy-3,5-dibutylphenylphosphine)]dichloride, cobalt bis[tris(4-methoxyphenylphosphine)]dichloride, cobalt bis[tris(3-methoxyphenylphosphine)]dichloride, cobalt bis[tris(4-dodecylphenylphosphine)]dichloride and cobalt bis[tris(4-ethylphenylphosphine)]dichloride etc.

As particularly preferred compounds of these, there can be mentioned cobalt bis(triphenylphosphine) dichloride, cobalt bis[tris(3-methylphenylphosphine)]dichloride, cobalt bis[tris(3,5-dimethylphenylphophine)]dichloride, cobalt bis[tris(4-methoxy-3,5-dimethylphenylphosphine)]dichloride, etc.

The amount of the cobalt compound used as a polymerization catalyst is preferably 0.001 to 1 mmol (in terms of cobalt atom), more preferably 0.01 to 0.5 mmol per 1 mol of butadiene in the case of homopolymerization of butadiene and per 1 mol of the total of butadiene and conjugated diene other than butadiene in the case of copolymerization thereof. Meanwhile, the amount of the phosphine compound used is preferably 0.1 to 50 in terms of the ratio (P/Co) of phosphorus atom to cobalt atom of cobalt compound, more preferably 0.5 to 20, particularly preferably 1 to 20. Also, the amount of the aluminoxane used is preferably 4 to 10⁷ in terms of the ratio (Al/Co) of aluminum atom to cobalt atom of cobalt compound, more preferably 10 to 10⁶. Incidentally, when there is used the complex represented by the general formula (5), the amount of the phosphine compound used is preferably 2 in terms of the ratio (P/Co) of phosphorus atom to the cobalt atom of cobalt compound, and the amount of the aluminoxane used is the same as mentioned above.

As the inert organic solvent used as a polymerization solvent, there can be mentioned, for example, aromatic hydrocarbon solvents such as benzene, toluene, xylene, cumene and the like; aliphatic hydrocarbon solvents such as n-pentane, n-hexane, n-butane and the like; alicyclic hydrocarbon solvents such as cyclopentane, methylcyclopentane, cyclohexane and the like; and mixed solvents thereof.

The polymerization temperature is preferably −50 to 120° C., more preferably −20 to 100° C. The polymerization reaction may be batch-wise or continuous. The monomers concentration in solvent is preferably 5 to 50 mass %, more preferably 10 to 35 mass %. In producing the polymer, it is preferred to minimize the incoming of a gas having a deactivating action, such as oxygen, water, carbon dioxide or the like, into the polymerization system, in order to prevent the deactivation of the catalyst used or the polymer formed. When the polymerization reaction has reached an intended stage, an alcohol or other polymerization terminators, an anti-aging agent, an anti-oxidizing agent, an ultraviolet radiation absorber, etc. are added to the reaction mixture. Then, the formed polymer is separated, washed and dried according to ordinary methods; thereby, a syndiotactic 1,2-polybutadiene can be obtained.

The weight-average molecular weight of syndiotactic 1,2-polybutadiene is preferably 10,000 to 5,000,000, more preferably 10,000 to 1,500,000, particularly preferably 50,000 to 1,000,000. When the weight-average molecular weight is less than 10,000, the fluidity is too high, the processing is difficult and the molded product (sheet for laser processing) tends to be sticky. Meanwhile, when the weight-average molecular weight is more than 5,000,000, the fluidity is too low and the processing tends to be difficult.

(A1-2) Hydrogenated, Diene-Based Copolymer

As the thermoplastic elastomer (A1) contained in the composition for laser processing, a hydrogenated, diene-based copolymer is used preferably. As the hydrogenated, diene-based copolymer, there can be mentioned, for example, hydrogenated products of diene-based polymers (hereinafter referred to also as “before-hydrogenation polymers”) such as homopolymer of conjugated diene monomer, random copolymer of conjugated diene monomer and vinyl aromatic monomer, block copolymer consisted of polymer block of vinyl aromatic monomer and copolymer block of conjugated diene monomer, block copolymer consisted of polymer block of vinyl aromatic monomer and random copolymer block of conjugated diene monomer and vinyl aromatic monomer, block copolymer consisted of polymer block of conjugated diene monomer and copolymer block of conjugated diene monomer and vinyl aromatic monomer, block copolymer consisted of polymer block of conjugated diene monomer and tapered block of vinyl aromatic monomer and conjugated diene monomer wherein the vinyl aromatic monomer increases gradually, block copolymer consisted of random copolymer block of conjugated diene monomer and vinyl aromatic monomer and tapered block of vinyl aromatic monomer and conjugated diene monomer wherein the vinyl aromatic monomer increases gradually, block copolymer consisted of polybutadiene block having a vinyl bond in an amount of 30 mass % or less and polymer block of conjugated diene monomer having a vinyl bond in an amount of more than 30 mass %, and the like.

of the above-mentioned hydrogenated, diene-based copolymers, preferred are hydrogenated products of conjugated diene-based polymers containing a polymer block A contained mainly of a vinyl aromatic monomer and a polymer block B contained mainly of a conjugated diene monomer; particularly preferred are hydrogenated products of diene-based copolymers having the block structures illustrated below.

The polymer block A is a homopolymer of a vinyl aromatic monomer, or wherein the polymer block A has a construction which a vinyl aromatic monomer unit containing 80 mass % or more, preferably more than 90 mass % of a vinyl aromatic monomer unit and other monomer copolymerizable (preferably a conjugated diene monomer) are copolymerized. The polymer block B is a homopolymer of a conjugated diene monomer, or wherein the polymer block B has a construction which a conjugated diene monomer and 20 mass % or less of other monomer (e.g. a vinyl aromatic monomer) are copolymerized. The block structures of such block copolymers are represented by (A-B)ₙ-A type (n is an integer of 1 to 10) or (A-B)ₘ type (m is an integer of 2 to 10). Incidentally, a relatively short polymer block B may be located at the terminal polymer block A.

The block copolymers further include one having a block structure represented by [(A-B)ₙ]ₘ—Y type (Y is a coupling agent residue, m is a valence of the coupling agent residue and is an integer of 2 to 4, and n is an integer of 1 to 10, preferably 1 or 2). Furthermore, the block copolymers may have a block structure of A₁-B-A₂ type or A₁-B₁-A₂-B₂ type. Incidentally, the respective mass-average molecular weights of polymer block B₁ and polymer block B₂ may be the same, or the mass-average molecular weight of polymer block B₂ may be smaller than the mass-average molecular weight of polymer block B₁.

As the vinyl aromatic monomer, there can be mentioned styrene, α-methylstyrene, p-methylstyrene, tert-butylstyrene, divinylbenzene, N,N-dimethyl-p-aminoethylstyrene, 2,4-dimethylstyrene, N,N-diethyl-p-aminoethylstyrene, 2,4-dimethylstyrene, vinylnaphthalene, vinyanthracene, etc. Of these, styrene and α-methylstyrene are preferred.

As the conjugated diene monomer, there can be mentioned monomers such as 1,3-butadiene, isoprene, 2,3-dimethyl-1,3-butadiene, 1,3-pentadiene, 2-methyl-1,3-pentadiene, 1,3-hexadiene, 4,5-dimethyl-1,3-octadiene, chloroprene and the like; and mixtures of at least two mentioned above. Of these, 1,3-butadiene and isoprene are preferred.

As the other monomer copolymerizable with a vinyl aromatic monomer, in the polymer block A, there can be mentioned mainly the same conjugated diene monomers as mentioned above. Of these, 1,3-butadiene and isoprene are preferred. As a preferred example of the other monomer copolymerizable with a conjugated diene monomer, in the polymer block B, styrene can be mentioned.

The proportions of the conjugated diene monomer and vinyl aromatic monomer constituting the before-hydrogenation polymer are preferably 95/5 to 40/60 in terms of mass ratio, more preferably 93/7 to 50/50, particularly preferably 92/8 to 60/40. The vinyl bond content of conjugated diene portion of before-hydrogenation polymer (the proportion of 1,2- and 3,4-vinyl bonds of conjugated diene portion of before-hydrogenation polymer) is not particularly restricted but is preferably 50 to 85%, more preferably 55 to 80%. With a proportion of less than 50%, the composition before crosslinking treatment is hard and tends to be difficult to handle. With a proportion of more than 85%, the crosslinking of the composition tends to be fairly difficult.

The before-hydrogenation polymer may be a polymer whose molecular chain is extended or branched via a coupling agent residue owing to the use of a coupling agent. As the coupling agent used, there can be mentioned, for example, diethyl adipate, divinylbenzene, methyldichlorosilane, tetrachlorosilane silicon tetrachloride, butyltrichlorosilane silicone, dimethyldichlorosilane, tetrachlorotin, butyltrichlorotin, dimethylchlorosilicon, tetrachlorogermanium, 1,2-dibromoethane, 1,4-chloromethylbenzene, bis(trichlorosilyl)ethane, epoxidized linseed oil, tolylene diisocyanate and 1,2,4-benzene triisocyanate etc.

As the hydrogenated, diene-based copolymer, there can be preferably used a hydrogenated product of a mixture of at least two kinds of before-hydrogenation polymers. Also, there can be preferably used a mixture of at least two kinds of hydrogenated, diene-based copolymers. In the hydrogenated, diene-based copolymer, the double bonds derived from conjugated diene monomer are saturated by hydrogenation in an amount of preferably 80% or more, more preferably 90%, particularly preferably 95% or more. A saturation amount of less than 80% tends to result in inferior the tolerance to an ink solvent. The hydrogenated, diene-based copolymer has a weight-average molecular weight of preferably 50,000 to 700,000, more preferably 50,000 to 600,000 in terms of polystyrene. With the molecular weight of less than 50,000, the strength obtained tends to be insufficient. Meanwhile, with the molecular weight of more than 700,000, the processability tends to be insufficient. Incidentally, the hydrogenated, diene-based copolymer can be produced, for example, by the method disclosed in JP-A-03-72512.

It is possible to use a modified, hydrogenated, diene-based copolymer obtained by introducing the above-mentioned, hydrogenated, diene-based copolymer into a functional group such as amino group, alkoxysilyl group, hydroxyl group, acid anhydride group, epoxy group or the like. As such a modified, hydrogenated, diene-based copolymer, there can be mentioned, for example, copolymers (a) to (c) shown below.

(a) A copolymer obtained by polymerizing a conjugated diene monomer or a vinyl aromatic monomer with a conjugated diene monomer in the presence of an organic alkali metal compound to obtain a copolymer, reacting the active sites of the copolymer with an epoxy compound or a ketone compound, and then hydrogenating the resultant product.

(b) A copolymer obtained by polymerizing a conjugated diene monomer or a vinyl aromatic monomer with a conjugated diene monomer in the presence of an organic alkali metal compound to obtain a copolymer, hydrogenating the copolymer, and reacting the resultant hydrogenated product with at least one member selected from the group consisting of a (meth)acryloyl group-containing compound, an epoxy group-containing compound and maleic anhydride, in a solution or in a kneader such as extruder or the like.

(c) A copolymer obtained by polymerizing a conjugated diene monomer or a vinyl aromatic monomer with a conjugated diene monomer in the presence of an organic alkali metal compound to obtain a copolymer, and reacting the resultant copolymer with a coupling agent such as epoxidized 1,2-polybutadiene, epoxidized soybean oil, epoxidized linseed oil, benzene-1,2,4-triisocyanate, diethyl oxalate, diethyl malonate, diethyl adipate, dioctyl adipate, dimethyl phthalate, diethyl phthalate, diethyl terephthalate, pyromellitic acid dianhydride or the like, to introduce the center of the molecular chain of the copolymer into a functional group such as —OH group, —NH—CO group, —NH₂ group, —NH— group or the like.

(A1-3) Styrene-Based Thermoplastic Elastomer

As the thermoplastic elastomer (A1) contained in the composition for laser processing, a styrene-based thermoplastic elastomer is used preferably. As the styrene-based thermoplastic elastomer, there is preferred a block copolymer (a particular block copolymer) consisted of at least one polymer block C made mainly of an aromatic vinyl compound and at least one polymer block D made mainly of a conjugated diene compound.

As a specific example of the particular block copolymer, there can be mentioned, for example, an aromatic vinyl compound-conjugated diene compound block copolymer having a block structure such as C-D, C-D-C, D-C-D-C, C-D-C-D-C or the like. In this aromatic vinyl compound-conjugated diene compound block copolymer, the proportion of the polymer block C is preferably 5 to 60 mass %, more preferably 10 to 50 mass %.

The polymer block C is a homopolymer of an aromatic vinyl monomer, or wherein the polymer block C has a construction which an aromatic vinyl compound of preferably 50 mass % or more, more preferably 70 mass % or more and a conjugated diene compound are copolymerized. The polymer block D is a homopolymer of a conjugated diene compound, or wherein the polymer block D has a construction which a conjugated diene compound of preferably 50 mass % or more, more preferably 70 mass % or more and an aromatic vinyl compound are copolymerized.

The number-average molecular weight (Mn) of the particular block copolymer is preferably 5,000 to 1,500,000, more preferably 10,000 to 550,000, particularly preferably 100,000 to 400,000. The polydispersity (Mw/Mn) of the particular block copolymer is preferably 10 or less. The molecular structure of the particular block copolymer may be any of a straight chain, a branched chain, a radial structure and combinations thereof.

In the molecular chain of the polymer block C or the polymer block D, the structural unit derived from a conjugated diene compound or an aromatic vinyl compound may be distributed at random, in a tapered state (wherein the monomer component increases or decreases along the molecular chain), partially in block, or in any combinations thereof. Incidentally, when the number of the block C is two or more and the number of the block D is two or more, the structures of these blocks C and these blocks D may be the same or different, respectively.

As the aromatic vinyl compound, there can be preferably mentioned at least one selected from the group consisting of styrene, α-methylstyrene, vinyltoluene and p-tert-butylstyrene. Of these, styrene is more preferred. As the conjugated diene compound, there can be preferably mentioned at least one selected from the group consisting of butadiene, isoprene, 1,3-pentadiene and 2,3-dimethyl-1,3-butadiene. Of these, butadiene, isoprene or a combination thereof are more preferred, and isoprene is particularly preferred.

As preferred examples of the styrene-based thermoplastic elastomer, there can be mentioned block copolymers such as styrene-butadiene-styrene block copolymer (SBS), styrene-isoprene-styrene block copolymer (SIS) and the like. Of these, particularly preferred is a styrene-isoprene-styrene block copolymer (SIS).

Incidentally, as the thermoplastic elastomer (A1), there can be used a single product or a combination of two or more products. Combination use of the syndiotactic 1,2-polybutadiene (A1-1) and the styrene-based thermoplastic elastomer (A1-3) is particularly preferred because the resulting composition for laser processing and the sheet for laser processing or flexographic printing plate produced therefrom are greatly improved in flexibility and transparency.

When the thermoplastic elastomer (A1) is a combination of the syndiotactic 1,2-polybutadiene (A1-1) and the styrene-based thermoplastic elastomer (A1-3), the mass ratio of the syndiotactic 1,2-polybutadiene (A1-1) and the styrene-based thermoplastic elastomer (A1-3) is preferably 80:20 to 20:80, more preferably 70:30 to 30:70. By specifying the mass ratio of the syndiotactic 1,2-polybutadiene (A1-1) and the styrene-based thermoplastic elastomer (A1-3) in the above range, there can be provided a composition for laser processing, a sheet for laser processing and a flexographic printing plate all superior in flexibility and transparency.

(A2) Non-Crosslinked Rubber

The composition for laser processing may preferably contain a non-crosslinked rubber in addition to the thermoplastic elastomer (A1). As the non-crosslinked rubber, there can be used a natural rubber, a synthetic rubber, a liquid polymer, etc. More specifically, there can be mentioned polybutadiene rubber, polyisoprene rubber, isobutylene-isoprene rubber, acrylonitrile-butadiene rubber, fluororubber, silicone rubber, halogenated butyl rubber (e.g. chlorinated butyl rubber or brominated butyl rubber), liquid butadiene rubber, liquid isoprene rubber, liquid polyisobutene rubber, liquid polybutene rubber, liquid ethylene-propylene rubber, liquid acrylonitrile-butadiene rubber, mixtures of two or more kinds thereof, etc. of these, preferred are polybutadiene rubber, polyisoprene rubber, liquid butadiene rubber, liquid isoprene rubber, liquid polyisobutene rubber, liquid polybutene rubber, liquid ethylene-propylene rubber and liquid acrylonitrile-butadiene rubber; and particularly preferred is liquid butadiene rubber. Incidentally, these non-crosslinked rubbers may be modified, at the molecular terminal, with a functional group such as hydroxyl group, carboxyl group, amino group or the like.

When the non-crosslinked rubber is a liquid butadiene rubber, the 1,2-vinyl content of the liquid butadiene rubber is preferably 60% or more, more preferably 80% or more, particularly preferably 85% or more. With the 1,2-vinyl content of 60% or more, the resulting composition for laser processing is superior in transparency and hardly becomes sticky by changing over time. The number-average molecular weight of the liquid butadiene rubber is preferably 1,500 or more and less than 10,000, more preferably 2,000 or more and less than 5,000. With the number-average molecular weight of 1,500 or more and less than 10,000, the liquid butadiene rubber is superior in processability and the resulting composition for laser processing hardly becomes sticky by changing over time. As a specific example of the liquid butadiene rubber satisfying the above requirements, there can be mentioned B-3000 and G-3000 (both are trade names) produced by Nippon Soda Co., Ltd.

The content of the non-crosslinked rubber (A2) is preferably 100 parts by mass or less relative to 100 parts by mass of the thermoplastic elastomer (A1), more preferably 5 to 80 parts by mass, particularly preferably 10 to 60 parts by mass. When the content of the non-crosslinked rubber is more than 100 parts by mass, the sheet for laser processing and flexographic printing plate tend to be sticky. Meanwhile, by containing the non-crosslinked rubber in an amount of 5 parts by mass or more, improvements in flexibility and moldability can be obtained. Incidentally, as the non-crosslinked rubber, a single product or a combination of two or more products can be used.

(B) Silica Particles

The composition for laser processing, which is a raw material for the sheet for laser processing used in production of the flexographic printing plate of the present embodiment, contains silica particles in an amount of 0.1 to 50 parts by mass, preferably 1 to 45 parts by mass, more preferably 5 to 40 parts by mass relative to 100 parts by mass of the thermoplastic elastomer (A1). When the content of the silica particles is less than 0.1 part by mass relative to 100 parts by mass of the thermoplastic elastomer (A1), the residue remaining after laser processing is sticky. Meanwhile, when the content is more than 50 parts by mass, there is impairment in flexibility and processability.

As the silica particles, various kinds of silica particles can be used. However, anhydrous silica particles are preferred because they can further prevent the offensive odor or flaming appearing during laser processing and the stickiness of processed surface. The average primary particle diameter of the silica particles is preferably 0.005 μm or more and less than 0.1 μm, more preferably 0.01 μm or more and less than 0.1 μm, particularly preferably 0.01 to 0.05 μm. When the average primary particle diameter of the silica particles is 0.1 μm or more, laser processability and washability after laser processing tends to be inferior. Meanwhile, when the average primary particle diameter is less than 0.005 μm, actual procurement of such silica particles tends to be difficult. As a preferred specific example of the silica particles to be contained in the composition for laser processing of the present embodiment, there can be mentioned AEROSIL (trade name, a product of Degussa Co.) etc. Incidentally, as the silica particles, a single product or a combination of two or more products can be used.

The composition for laser processing may contain, as necessary, a crosslinking co-agent, an initiator, a thermal addition polymerization inhibitor, a coloring agent, an anti-oxidizing agent, a plasticizer, a reinforcing agent, an active agent, a flame retardant, an anti-aging agent, a pigment, other polymer, etc. As the crosslinking co-agent and initiator, there can be mentioned (1) alkyl (meth)acrylates such as methyl(meth)acrylate, ethyl (meth)acrylate, n-butyl(meth)acrylate, isobutyl (meth)acrylate, tert-butyl(meth)acrylate, n-hexyl (meth)acrylate, 2-ethylhexyl(meth)acrylate, lauryl (meth)acrylate and dicyclopentenyl(meth)acrylate; (2) ether type (meth)acrylates such as 2-methoxyethyl(meth)acrylate, 2-ethoxyethyl(meth)acrylate, 3-methoxybutyl(meth)acrylate, ethylcarbitol (meth)acrylate, phenoxyethyl(meth)acrylate, methoxypropylene glycol (meth)acrylate, n-butoxyethyl (meth)acrylate, methoxytriethylene glycol (meth)acrylate, glycidyl(meth)acrylate; (3) alcohol type (meth)acrylates such as 2-hydroxyethyl(meth)acrylate, 2-hydroxypropyl (meth)acrylate, 2-hydroxybutyl(meth)acrylate, 4-hydroxybutyl (meth)acrylate, 2-(meth)acryloyloxyethyl-2-hydroxypropyl phthalate and 2-hydroxy-3-phenoxypropyl acrylate; (4) carboxylic acid type (meth)acrylates such as 2-(meth)acryloyloxyethyl succinate, 2-methacryloyloxyethyl hexahydrophthalate, ω-carboxy-polycaprolactone mono(meth)acrylate and acrylic acid dimer; (5) bifunctional acrylates such as 1,4-butanediol di(meth)acrylate, 1,3-butylene glycol di(meth)acrylate, 1,6-hexanediol di(meth)acrylate, 1,9-nonanediol di(meth)acrylate, neopentyl glycol di(meth)acrylate, ethylene glycol di(meth)acrylate, triethylene glycol di(meth)acrylate, polyethylene glycol di(meth)acrylate, tripropylene glycol di(meth)acrylate, polypropylene glycol di(meth)acrylate, tetraethylene glycol di(meth)acrylate, 1,4-cyclohexanedimethanol di(meth)acrylate, Ethoxylated bisphenol A di(meth)acrylate, and Ethoxylated bisphenol F di(meth)acrylate; (6) polyfunctional acrylates such as trimethylolpropane tri(meth)acrylate, pentaerythritol tri(meth)acrylate, trimethylolpropane EO-modified tri(meth)acrylate, trimethylolpropane PO-modified tri(meth)acrylate, pentaerythritol tetra(meth)acrylate and dipentaerythritol hexa(meth)acrylate; ethylenic unsaturated group-containing polybutadiene oligomer or urethane acrylate polymer; etc.

The above crosslinking co-agent and initiator are preferably used each in an amount of 0.1 part by mass or more relative to 100 parts by mass of the thermoplastic elastomer (A1). When the use amount is less than 0.1 part by mass, there are cases that sufficient mechanical strengths and laser processability are not exhibited.

As the polymerization initiator, known initiators can be used. There can be used, for example, benzophenone, Michler's ketone, 4,4′-bis(dimethylamino)benzophenone, 4,4′-bis(diethylamino)benzophenone, 4-acryloxy-4′-dimethylaminobenzophenone, 4-acryloxy-4′-diethylaminobenzophenone, 2,2-dimethoxy-1,2-diphenylethan-1-one (2-phenyl-2,2-dimethoxyacetophenone), 2,2-diethoxy-1,2-diphenylethan-1-one, 1-hydroxycyclohexylphenyl ketone, 2-hydroxy-2-methyl-1-phenylpropan-1-one, 1-[4(2-hydroxyethoxy)phenyl]-2-hydroxy-2-methyl-1-propan-1-one, 2-methyl-1[4-(methylthio)phenyl]-2-morpholinopropan-1-one, 2-benzyl-2-dimethylamino-1-(4-morpholinophenyl)-butanone-1, bis(2,6-dimethoxybenzoyl)-2,4,4-trimethylpentylphosphine oxide, etc.

The polymerization initiator is used in an amount of preferably 0 to 10 parts by mass, more preferably 0 to 5 parts by mass, particularly preferably 0 to 3 parts by mass relative to 100 parts by mass of the thermoplastic elastomer (A1). Use of more than 10 parts by mass is uneconomical and moreover tends to give a composition which is too hard and fragile.

As examples of the thermal addition polymerization inhibitor, there can be mentioned hydroxyaromatic compounds such as hydroquinone, alkylhydroquinone, alkoxyhydroquinone, allylhydroquinone, p-methoxyphenol, tert-butylpyrocatechol, pyrogallol, β-naphthol, 2,6-di-tert-butyl-p-cresol and the like; quinones such as benzoquinone, 2,5-diphenyl-p-benzoquinone, p-toluquinone, p-xyloquinone and the like; nitro or nitroso compounds such as nitrobenzene, m-dinitrobenzene, 2-methyl-2-nitrosopropane, α-phenyl-tert-butylnitron, 5,5-dimethyl-1-pyrroline-1 oxide and the like; amines such as chloranil-amines, diphenylamine, diphenylpicrylhydrazine, phenol-α-naphthylamine, pyridine, phenothiazine and the like; sulfides such as dithiobenzoyl sulfide, dibenzyl tetrasulfide and the like; unsaturated compounds such as 1,1-diphenylethylene, α-methylthioacrylonitrile and the like; thiazine dyes such as Thionine Blue, Toluidine Blue, Methylene Blue and the like; and stable radicals such as 1,1-diphenyl-2-picrylhydrazine, 1,3,5-triphenylverdazine (phonetic expression), 4-hydroxy-2,2,6,6-tetramethylpiperidin-1-oxyl, 2,6-di-tert-butyl-α-(3,5-di-tert-butyl)-4-oxo-2,5-cyclohexadien-1-ylidene-p-trioxyl and the like.

The amount of the thermal addition polymerization inhibitor used is preferably 0.01 to 5 parts by mass per 100 parts by mass of the thermoplastic elastomer (A1). The thermal addition polymerization inhibitor may be used as a single product or as a mixture of two or more products.

As examples of the coloring agent, there can be mentioned basic dyes such as Victoria Pure Blue, Victoria Blue, Methyl Violet, Aizen Malachite Green (these are products of Hodogaya Chemical Co., Ltd.), Patent Pure Blue VX, Rhodamine B, Methylene Blue (these are products of Sumitomo Chemical Co., ltd.) and the like; oil-soluble dyes such as Sudan Blue II, Victoria Blue F4R (these are products of BASF), Oil Blue # 603, Oil Blue BOS, Oil Blue IIN (these are products of Orient Chemical Industry Co., Ltd.) and the like; and organic coloring agents such as Benzidine Yellow G, Brilliant Carmine 6B, Permanent F-5R, Lake Red C, Phthalocyan Green and the like. There can also be used inorganic coloring agents such as titanium oxide, zinc oxide, lithopone, white lead, lead yellow, cadmium yellow, barium yellow, cadmium red, molybdate orange, red lead (minium), amber, ultramarine, prussian blue, cobalt blue, chromic oxide green, cobalt violet and the like. These coloring agents can be used singly or as a mixture of two or more kinds.

As examples of the anti-oxidizing agent, there can be mentioned 2,6-di-tert-butyl-p-cresol, 2,2-methylene-bis(4-methyl-6-tert-butylphenol), pentaerythrityl tetrakis[3-(3,5-di-tert-butyl-4-hydroxyphenyl)propionate, 2,4-bis[(octylthio)methyl]-o-cresol and tris(3,5-di-tert-butyl-4-hydroxybenzyl)-isocyanurate etc.

As the reinforcing agent, there can be used not only carbon black but also white reinforcing agents such as calcium carbonate, special calcium carbonate type compound consisting of a composite of calcium carbonate and magnesium carbonate, magnesium carbonate, clay, talc and the like. These reinforcing agents can be used singly or as a combination of two or more kinds.

As the active agent, there can be used Chinese white (zinc oxide) which also has a function as a vulcanization co-accelerator. Besides the ordinary grade, there can also be used special grades such as active Chinese white, transparent Chinese white, surface-treated Chinese white, complex zinc white and the like. Also, as other inorganic active agents, there can be used MgO, red lead, white lead, etc. Also, there can be used organic active agents; that is, fatty acids such as stearic acid, oleic acid, lauric acid and the like, and fatty acid derivatives such as zinc stearate, dibutylammonium oleate and the like.

As the flame retardant, there can be used compounds of antimony oxide type, antimony type, chlorinated paraffin type, bromine type, zirconium type or phosphate type; aluminum hydroxide; magnesium hydroxide; zinc borate; etc. As the anti-aging agent, there can be used compounds of p-phenylenediamine type, quinoline type, phenol type, hindered phenol type, etc.

The sheet for laser processing, used for producing the flexographic printing plate of the present embodiment is a sheet which is obtained by forming the above-mentioned composition for laser processing into a shape of a sheet and whose at least one side is a to-be-processed side. Therefore, this sheet for laser processing causes neither offensive odor nor flaming during processing, shows no stickiness at the processed surface.

The sheet for laser processing is preferably a sheet subjected to a crosslinking treatment. When the crosslinked sheet is laser-processed, the peripheral portion of processed side where the portion is not engraved (the area to be left without being engraved) is sparingly soluble, making it possible to form a printing pattern at a high engraving precision. As the method for crosslinking treatment, there can be mentioned, for example, electron beam (EB) crosslinking, ultraviolet (UV) crosslinking, and thermal crosslinking etc. Incidentally, the sheet for laser processing can be produced by subjecting the composition for laser processing, to extrusion, calendering, pressing, etc. When the sheet for laser processing is produced by extrusion, EB crosslinking or UV crosslinking which enables crosslinking during extrusion is preferred from a viewpoint of production efficiency.

When the sheet for laser processing is produced by using EB crosslinking, the exposure of electron beam is preferably 200 Mrad or less, more preferably 100 Mrad or less. With the exposure of electron beam, of more than 200 Mrad, the resulting sheet for laser processing is hard and tends to be insufficient in flexibility. The acceleration voltage of electron beam is preferably 800 kV or less. With the acceleration voltage of more than 800 kV, a electron beam generator tends to be too expensive, which is not practical.

When the sheet for laser processing is a sheet which has been subjected to a crosslinking treatment, the proportion of the gel (toluene gel content) obtained by 3 hours extraction with toluene of 60° C., to the total sheet is preferably 50 mass % or more, more preferably 70 mass % or more, particularly preferably 80 mass % or more. When the toluene gel content is less than 50 mass %, the precision (engravability) during laser processing tends to be inferior.

Also, the sheet for laser processing is preferred to be a sheet having a sheet-shaped base material layer laminated on one side. Such a laminate enables printing pressure needed to lower when printing is made onto the flexographic printing plate. Also, the total weight of the sheet for laser processing can be made light and, therefore, such a sheet is suitable for producing a relatively large sheet (flexographic printing plate). Incidentally, as the material constituting the base material layer, there can be mentioned, for example, various single elastomers and products of photo-polymerizing compositions containing an elastomer, an ethylenically unsaturated group-containing compound and a photo-polymerization initiator produced by photo-curing etc.

The above elastomers are not particularly restricted. There can be mentioned rubbers such as natural rubber, butadiene rubber, styrene-butadiene rubber, isoprene rubber, acrylonitrile-butadiene rubber, acrylic rubber, butyl rubber, fluororubber, silicone rubber, urethane rubber and the like; a thermoplastic elastomer; etc. Of these, the thermoplastic rubber is used preferably. As examples of the thermoplastic elastomer, there can be mentioned polyolefin type thermoplastic elastomer, styrene-based thermoplastic elastomer, diene-based thermoplastic elastomer, urethane-based thermoplastic elastomer, polyester type thermoplastic elastomer, polyamide type thermoplastic elastomer, vinyl chloride-based thermoplastic elastomer and fluorine-containing thermoplastic elastomer.

As the polyolefin type thermoplastic elastomer (TPO), there can be mentioned, for example, simple blend type TPO, implant TPO, and dynamic vulcanization type TPO etc. As the styrene-based thermoplastic elastomer, there can be mentioned, for example, block copolymers of aromatic vinyl compound and conjugated diolefin, such as styrene-butadiene block copolymer, styrene-butadiene-styrene block copolymer, styrene-(styrene-butadiene)-styrene block copolymer, styrene-isoprene-styrene block copolymer, styrene-(ethylene-butylene)-styrene block copolymer, styrene-(ethylene-propylene)-styrene block copolymer, hydrogenated polymer of random styrene-butadiene rubber, the above block copolymers wherein part or the whole portion of styrene has been replaced with α-methylene, and the like; and hydrogenated products of these block copolymers.

As the diene-based thermoplastic elastomer, there can be mentioned, for example, syndiotactic 1,2-polybutadiene and trans 1,4-polyisoprene etc. As the polyester type thermoplastic elastomer, there can be mentioned, for example, multi-block polymers using a polybutylene terephthalate as a hard segment and a polytetramethylene ether glycol as a soft segment etc. As the polyamide type thermoplastic elastomer, there can be mentioned, for example, block polymers using a nylon as a hard segment and a polyester or a polyol as a soft segment etc.

As the thermoplastic elastomer, there can be preferably used, in view of the balance of properties such as material hardness, impact resilience and the like and the processability, styrene-butadiene-styrene block copolymer, styrene-isoprene-styrene block copolymer, styrene-ethylene/butylene-styrene block copolymer, styrene-ethylene/propylene-styrene block copolymer, hydrogenated polymer of random styrene-butadiene rubber, etc. Incidentally, these thermoplastic elastomers can be used singly or in combination of two or more kinds.

As to the ethylenically unsaturated group-containing compound, there is no particular restriction as long as, when mixed with the above-mentioned elastomer, it is miscible with the binder polymer in such an extent that a transparent and non-cloudy photo-polymerized layer is formed. Specifically, there can be mentioned (1) alkyl(meth)acrylates such as methyl(meth)acrylate, ethyl(meth)acrylate, n-butyl (meth)acrylate, isobutyl(meth)acrylate, tert-butyl (meth)acrylate, n-hexyl(meth)acrylate, 2-ethylhexyl (meth)acrylate, lauryl(meth)acrylate and dicyclopentenyl (meth)acrylate; (2) ether type (meth)acrylates such as 2-methoxyethyl(meth)acrylate, 2-ethoxyethyl(meth)acrylate, 3-methoxybutyl(meth)acrylate, ethylcarbitol (meth)acrylate, phenoxyethyl(meth)acrylate, methoxypropylene glycol (meth)acrylate, n-butoxyethyl(meth)acrylate, methoxytriethylene glycol (meth)acrylate, glycidyl (meth)acrylate; (3) alcohol type (meth)acrylates such as 2-hydroxyethyl(meth)acrylate, 2-hydroxypropyl(meth)acrylate, 2-hydroxybutyl(meth)acrylate, 4-hydroxybutyl(meth)acrylate, 2-(meth)acryloyloxyethyl-2-hydroxypropyl phthalate and 2-hydroxy-3-phenoxypropyl acrylate; (4) carboxylic acid type (meth)acrylates such as 2-(meth)acryloyloxyethyl succinate, 2-methacryloyloxyethyl hexahydrophthalate, ω-carboxy-polycaprolactone mono(meth)acrylate and acrylic acid dimer; (5) bifunctional acrylates such as 1,4-butanediol di(meth)acrylate, 1,3-butylene glycol di(meth)acrylate, 1,6-hexanediol di(meth)acrylate, 1,9-nonanediol di(meth)acrylate, neopentyl glycol di(meth)acrylate, ethylene glycol di(meth)acrylate, triethylene glycol di(meth)acrylate, polyethylene glycol di(meth)acrylate, tripropylene glycol di(meth)acrylate, polypropylene glycol di(meth)acrylate, tetraethylene glycol di(meth)acrylate, 1,4-cyclohexanedimethanol di(meth)acrylate, Ethoxylated bisphenol A di(meth)acrylate, and Ethoxylated bisphenol F di(meth)acrylate; (6) polyfunctional acrylates such as trimethylolpropane tri(meth)acrylate, pentaerythritol tri(meth)acrylate, trimethylolpropane EO-modified tri(meth)acrylate, trimethylolpropane PO-modified tri(meth)acrylate, pentaerythritol tetra(meth)acrylate and dipentaerythritol hexa(meth)acrylate; ethylenic unsaturated group-containing polybutadiene oligomer or urethane acrylate polymer; etc.

The ethylenically unsaturated group-containing compound is used in an amount of preferably 3 parts by mass or more per 100 parts by mass of the above elastomer. When the amount is less than 3 parts by mass, exhibition of sufficient mechanical strengths and elasticity tends to be difficult.

As the photo-polymerization initiator, known initiators can be used. There can be used, for example, benzophenone, Michler's ketone, 4,4′-bis(dimethylamino)benzophenone, 4,4′-bis(diethylamino)benzophenone, 4-acryloxy-4′-dimethylaminobenzophenone, 4-acryloxy-4′-diethylaminobenzophenone, 2,2-dimethoxy-1,2-diphenylethan-1-one (2-phenyl-2,2-dimethoxyacetophenone), 2,2-diethoxy-1,2-diphenylethan-1-one, 1-hydroxycyclohexylphenyl ketone, 2-hydroxy-2-methyl-1-phenylpropan-1-one, 1-[4(2-hydroxyethoxy)phenyl]-2-hydroxy-2-methyl-1-propan-1-one, 2-methyl-1[4-(methylthio)phenyl]-2-morpholinopropan-1-one, 2-benzyl-2-dimethylamino-1-(4-morpholinophenyl)-butanone-1, bis(2,6-dimethoxybenzoyl)-2,4,4-trimethylpentylphosphine oxide, etc.

The photo-polymerization initiator is used in an amount of preferably 0.01 to 20 parts by mass, more preferably 0.05 to 15 parts by mass, particularly preferably 0.1 to 10 parts by mass relative to 100 parts by mass of the thermoplastic elastomer (A1). When the use amount is less than 0.01 part by mass, the curing of the resulting composition tends to be insufficient. Meanwhile, use of more than 20 parts by mass is uneconomical and moreover tends to give a composition which is too hard and fragile.

The photo-polymerizing composition may contain, as necessary, a thermal addition polymerization inhibitor, a coloring agent, an anti-oxidizing agent, a plasticizer, etc. each in a small amount. As examples of the thermal addition polymerization inhibitor, there can be mentioned hydroxyaromatic compounds such as hydroquinone, alkylhydroquinone, alkoxyhydroquinone, allylhydroquinone, p-methoxyphenol, tert-butylpyrocatechol, pyrogallol, β-naphthol, 2,6-di-tert-butyl-p-cresol and the like; quinones such as benzoquinone, 2,5-diphenyl-p-benzoquinone, p-toluquinone, p-xyloquinone and the like; nitro or nitroso compounds such as nitrobenzene, m-dinitrobenzene, 2-methyl-2-nitrosopropane, α-phenyl-tert-butylnitron, 5,5-dimethyl-1-pyrroline-1 oxide and the like; amines such as chloranil-amines, diphenylamine, diphenylpicrylhydrazine, phenol-α-naphthylamine, pyridine, phenothiazine and the like; sulfides such as dithiobenzoyl sulfide, dibenzyl tetrasulfide and the like; unsaturated compounds such as 1,1-diphenylethylene, α-methylthioacrylonitrile and the like; thiazine dyes such as Thionine Blue, Toluidine Blue, Methylene Blue and the like; and stable radicals such as 1,1-diphenyl-2-picrylhydrazine, 1,3,5-triphenylverdazine (phonetic expression), 4-hydroxy-2,2,6,6-tetramethylpiperidin-1-oxyl, 2,6-di-tert-butyl-α-(3,5-di-tert-butyl)-4-oxo-2,5-cyclohexadien-1-ylidene-p-trioxyl and the like.

The amount of the thermal addition polymerization inhibitor used is preferably 0.01 to 5 mass % relative to the photo-polymerizing composition. The thermal addition polymerization inhibitor may be used as a single product or as a mixture of two or more products.

As examples of the coloring agent, there can be mentioned basic dyes such as Victoria Pure Blue, Victoria Blue, Methyl Violet, Aizen Malachite Green (these are products of Hodogaya Chemical Co., Ltd.), Patent Pure Blue VX, Rhodamine B, Methylene Blue (these are products of Sumitomo Chemical Co., ltd.) and the like; oil-soluble dyes such as Sudan Blue II, Victoria Blue F4R (these are products of BASF), Oil Blue # 603, Oil Blue BOS, Oil Blue IIN (these are products of Orient Chemical Industry Co., Ltd.) and the like; and organic coloring agents such as Benzidine Yellow G, Brilliant Carmine 6B, Permanent F-5R, Lake Red C, Phthalocyan Green and the like. There can also be used inorganic coloring agents such as titanium oxide, zinc oxide, lithopone, white lead, lead yellow, cadmium yellow, barium yellow, cadmium red, molybdate orange, red lead (minium), amber, ultramarine, prussian blue, cobalt blue, chromic oxide green, cobalt violet and the like. These coloring agents can be used singly or as a mixture of two or more kinds.

As examples of the anti-oxidizing agent, there can be mentioned 2,6-di-tert-butyl-p-cresol, 2,2-methylene-bis(4-methyl-6-tert-butylphenol), pentaerythrityl tetrakis[3-(3,5-di-tert-butyl-4-hydroxyphenyl)propionate], 2,4-bis[(octylthio)methyl]-o-cresol and tris-(3,5-di-tert-butyl-4-hydroxybenzyl)-isocyanurate etc.

As examples of the plasticizer, there can be mentioned process oils (e.g. aromatic type, naphthenic type and paraffinic type) used ordinarily in rubber processing; dialkyl phthalates such as dibutyl phthalate, dihexyl phthalate, di-2-ethylhexyl phthalate, diheptyl phthalate, dioctyl phthalate, dinonyl phthalate and the like; and dialkyl adipates such as di-2-ethylhexyl adipate, dioctyl adipate, diisodecyl adipate and the like.

The thickness of the base material layer is preferably 1 to 7 mm, more preferably 2 to 6 mm, particularly preferably 3 to 5 mm. When the thickness of the base material layer is less than 1 mm, the base material layer tends to hardly exhibit sufficient strength and properties as a base material. Meanwhile, when the thickness is more than 7 mm, the resulting printing plate tends to be too heavy, which tends to give reduced workability.

The thickness of the sheet for laser processing is preferably 0.5 to 7 mm, more preferably 1 to 3 mm. When the thickness is less than 0.5 mm, the laser applied tends to pierce through the sheet easily depending upon the intensity, etc. of the laser. Meanwhile, a thickness of more than 7 mm is too large; therefore, the handleability of the sheet is low and, moreover, its crosslinkability using UV or EB tends to be low. Incidentally, when the total thickness of the sheet for laser processing is 3 mm or more, it is preferred that the sheet-shaped layer of the composition for laser processing (the layer to be laser-processed) has a thickness of 3 mm or less and a base material layer as mentioned above is formed thereon.

Next, description is made on an embodiment of the method for producing the flexographic printing plate of the present invention. In the method for producing the flexographic printing plate of the present embodiment, which comprises a plate formed in a form of sheet from a composition 100 parts by mass of (A1) a thermoplastic elastomer and 0.1 to 50 parts by mass of (B) silica particles, and has an intended printing pattern formed on at least one side which is a side to be subjected to laser processing of the plate formed in a form of sheet for laser processing by subjecting the at least one side to laser processing for engraving. Therefore, according to the method for producing the flexographic printing plate of the present embodiment, there can be easily produced a flexographic printing plate which has good flexibility and further is not sticky at the processed surface, is superior in transparency and has a printing pattern of high engraving precision and sufficient engraving depth, without causing any offensive odor or flaming during laser processing.

As the laser oscillator used in engraving the to-be-processed side of the sheet for laser processing, a carbon dioxide gas laser can be mentioned mainly. The intensity of the laser applied depends upon the thickness of using sheet or the intended depth of engraving but is preferably 10 to 500 W, more preferably 10 to 300 W per one laser source. With the intensity of less than 10 W, formation of a printing pattern having a sufficient engraving depth tends to be difficult. Meanwhile, when the intensity is more than 500 W, an engraving precision tends to deteriorate since the intensity is too high. In general, in order to obtain an increased speed of laser processing, it is preferred to increase the number of laser sources to process multiple sites simultaneously rather than to increase the intensity per one laser source.

The process of engraving by laser can be conducted by placing the sheet for laser processing horizontally. It can also be conducted by setting the sheet for laser processing onto a roll made of, for example, a metal. After the process of engraving by laser, the processed side is preferably washed to remove the ash generated (residue). The washing of the processed side can be conducted by solvent washing using water or an appropriate organic solvent, or by air washing in which an air current is sprayed.

### EXAMPLES

The present invention is described in more detail below by way of Examples. However, the present invention is in no way restricted to these Examples. Incidentally, in the following Examples and Comparative Examples, “parts” and “%” are both based on mass unless otherwise specified. Also, the methods for measurement of properties are shown below.

(1) Methods for Measurement and Evaluation of Properties

[Vinyl Bond Content]

Infrared analysis was used and calculation was made by the Molero method.

[Hydrogenation Ratio]

The ratio was calculated from 100 MHz ¹H-NMR spectrum by using carbon tetrachloride as a solvent.

[Weight-Average Molecular Weight]

Gel permeation chromatography (GPC) at 40° C. was used with tetrahydrofuran as a solvent, and the weight-average molecular weight was calculated in terms of polystyrene.

[Bound Styrene Content]

The content was calculated from 270 MHz ¹H-NMR spectrum by using carbon tetrachloride as a solvent.

[Melt Flow Rate (MFR) (1)]

Measured at 230° C. at a load of 21.2 N based on JIS K 7210. A larger MFR indicates superior moldability.

[Hardness]

Using “ASKER CL150/DD2 DUROMETER” (trade name) produced by Kobunshi Keiki Sha, a constant load method and an instantaneous value were recorded based on JIS K 6253.

[Crystallinity (of Syndiotactic 1,2-Polybutadiene)]

Crystallinity was calculated from density, which was measured according to an in-water substitution method by using 0.889 g/cm³ as the density of syndiotactic 1,2-polybutadiene of 0% crystallinity and 0.963 g/cm³ as the density of syndiotactic 1,2-polybutadiene of 100% crystallinity.

(2) Production of Syndiotactic 1,2-Polybutadiene

600 g of 1,3-butadiene (BD) and 2,400 g of cyclohexane were placed in a 5-liter autoclave purged with dried nitrogen. Thereto were added a methylene chloride solution containing 0.4% cobalt bis(triphenylphosphine) dichloride, produced by Aldrich Co. and a toluene solution containing 20% methylaluminoxane (produced by Albemarle Co.) in an amount of 1% in terms of Al atom, so as to give a BD/Co molar ratio of 120,000 and an Al/Co atomic ratio of 75. Polymerization was conducted for 120 minutes while the inside temperature was being controlled at 55° C. The reaction was terminated by adding a small amount of ethanol as a polymerization terminator. Then, 2,6-di-tert-butyl-p-cresol was added in an amount of 0.3 part per 100 part of the polymer formed. The mixture was heated on a hot plate to obtain 510 g of a polymer [syndiotactic 1,2-polybutadiene (a-1)] by removing the solvent. Incidentally, this polymer had a weight-average molecular weight of 200,000, a density of 0.901, a calculated crystallinity of 16%.

(3) Production of Hydrogenated, Diene-Based Copolymers

Into a 50-liter autoclave were fed 25 kg of degassed and dehydrated cyclohexane, 150 g of tetrahydrofuran and 450 g of styrene. Then, 4.5 g of n-butyllithium was added. Adiabatic polymerization was conducted from 50° C. for 20 minutes. After the temperature of reaction mixture was set at 5° C., 4,250 g of 1,3-butadiene was added, and adiabatic polymerization was conducted. After the conversion rate became approximately 100%, 300 g of styrene was further added for polymerization. After the polymerization was completed, hydrogen gas was supplied at a pressure of 0.4 MPa-G and stirring was conducted for 20 minutes to react with the polymer terminal lithium which was living as a living anion, and then lithium hydride was obtained. The reaction mixture was set at 90° C., after which a hydrogenation reaction was conducted using titanocene dichloride as a hydrogenation catalyst to obtain a hydrogenated, diene-based copolymer (a-2). The hydrogenated, diene-based copolymer (a-2) had a hydrogenation ratio of 98.5%, a weight-average molecular weight of 150,000, a bound styrene content of 15%, a vinyl bond content of 65% and an MFR of 3.0 g/10 min.

A hydrogenated, diene-based copolymer (a-3) was obtained in the same manner by changing, as shown in Table 1, the amounts of monomers, the addition amount of tetrahydrofuran, the amount of catalyst, the polymerization temperature, the polymerization time, etc. The results of the measured properties of the hydrogenated, diene-based copolymers are shown in Table 1.

TABLE 1

| | | | Hydrogenated, diene- | |
|---|---|---|---|---|
| | | | based copolymer | |
| | | | a-2 | a-3 |
| Before- | Block structure | | S-B-S | S-B-S |
| hydrogenation | Styrene | Content (%) | 15 | 15 |
| Copolymer | block | | | |
| | Butadiene | Content (%) | 85 | 85 |
| | block | Vinyl bond | 65 | 78 |
| | | content (%) | | |

| | | |
|---|---|---|
| Weight-average molecular weight (×10⁴) | 15 | 12 |
| MFR (g/10 min) | 3.0 | 30 |
| Hydrogenation ratio (%) | 98.5 | 96 |

(4) As other thermoplastic elastomer (A1), there was used a styrene-isoprene-styrene block copolymer (a-4) [“JSR SIS 5405” (trade name) produced by JSR Co., Ltd.]. Also, as the non-crosslinked rubber (A2), there were used a liquid polybutadiene (b-1) [“B 3000” (trade name) produced by Nippon Soda Co., Ltd.; weight-average molecular weight: 3,000; 1,2-vinyl bond content: 92%], a hydrogenated, liquid polybutadiene (b-2) [“B 13000” (trade name) produced by Nippon Soda Co., Ltd.; weight-average molecular weight: 3,000], a liquid polybutadiene (b-3) [“RHPB” (trade name) produced by JSR Co., Ltd.; 1,2-vinyl bond content: 25%], and a liquid ethylene-propylene rubber (b-4) [“LUCANT HC-150” (trade name) produced by Mitsui Chemical Co., Ltd.].

### Example 1

(1) Into a kneader whose temperature was controlled at 150° C., there were fed 100 parts of the syndiotactic 1,2-polybutadiene (a-1), 40 parts of a silica [“AEROSIL R 972” (trade name) produced by NIPPON AEROSIL CO., LTD.; average primary particle diameter=0.017 μm], 1 part of a silane coupling agent [“TSL 8370” (trade name) produced by GE Toshiba Silicone Co., Ltd.] and 2 parts of stearylamine as a lubricant. They were kneaded for 30 minutes to prepare a composition for laser processing. The resultant composition for laser processing was made into a sheet using a 10-inch roll whose temperature was controlled at 50° C., and the sheet was filled in a die having a depth of 2 mm. The sheet was pressed for 10 minutes using a compression molding machine whose temperature was controlled at 170° C.; then, the sheet was cooled to room temperature, taken out, and irradiated with an electron beam of 800 kV (acceleration voltage) and 20 Mrad using an electron beam irradiation apparatus [“EPS 800-35” (trade name) produced by Nisshin High Voltage Co.] to produce a sheet for laser processing, having a thickness of 2 mm. Incidentally, the side of the sheet irradiated with the electron beam is a side to be later subjected to laser processing.

(2) Into a kneader whose temperature was controlled at 50° C., there were fed 100 parts of a styrene-isoprene-styrene block copolymer [“JSR SIS 5000” (trade name) produced by JSR Co., Ltd.], 10 parts of 1,6-hexanediol dimethacrylate, 2 parts of 2,2-dimethoxy-1,2-diphenylethan-1-one (a photo-polymerization initiator) and 1 part of 2,6-di-tert-butylcresol (a thermal addition polymerization inhibitor). They was kneaded for 30 minutes to obtain a colorless transparent photo-polymerizing composition.

(3) The sheet for laser processing, produced in the above (1) was lightly polished with a sandpaper (#200) at the side not irradiated with an electron beam and then laid in a mold having a depth of 7 mm. Thereon was placed the photo-polymerizing composition obtained in the above (2). Thereon was further placed a polyester film having a thickness of 200 μm. They were molded using a press whose temperature was controlled at 90° C., to obtain a flexible laminate having a total thickness of 7 mm. The laminate was exposed at a ultraviolet intensity of 25 W/m² for 5 minutes from the side of the layer consisted of the photo-polymerizing composition, using an exposure apparatus (Model “JE-A3-SS” produced by Nihon Denshi Seiki Sha), to obtain a sheet for laser processing, having a base material layer laminated.

(4) There was used a laser processing machine [“Laser Pro” (trade name) produced by Great Computer Corporation] mounting thereon a closed type carbon dioxide laser oscillator (a product of US Synrad Co.; output=25 W), by setting the SPEED at 30%, the POWER at 95% and the resolution at 1,000 (dpi). The sheet for laser processing obtained in the above (3) was subjected to laser processing to obtain a flexographic printing plate (Example 1). Incidentally, there were evaluated flaming during processing, stickiness at the processed surface, odor (organoleptic test), and engraving precision. The standards used for evaluation of the flaming during processing, the stickiness at the processed surface, and the odor are shown below. Engraving precision was judged by observing the processed surface using a surface observation apparatus (a product of Keyence Co.). The results of evaluation are shown in Table 2.

[Flaming]

◯: No flaming or practically no flaming
X: Big flaming
   [Odor]
◯: No odor or practically no odor
X: Strong odor
   [Stickiness]
◯: No stickiness or practically no stickiness
Δ: Slight stickiness
X: Severe stickiness
   [Engraving Precision]
◯: Upon observation with a microscope, a line of 0.1 mm in width was engraved.
X: Upon observation with a microscope, a line of 0.1 mm in width was not engraved.
   (5) Measurement of toluene gel content: The toluene gel content of the sheet for laser processing before lamination of base material layer was measured according to the following method. 2 g of the sheet for laser processing was cut into a square of about 1 mm×1 mm; the square was extracted in 100 ml of toluene of 60° C. for 3 hours; then, solid portion was collected using a wire net of 400 mesh. The resultant solid portion was vacuum-dried at 80° C. for 2 hours to evaporate toluene; thereafter, a toluene gel content (%) was measured. The result of the measurement is shown in Table 2.

### Example 2

A sheet for laser processing, having a base material layer laminated was obtained in the same manner as in Example 1 except that 1.5 parts of trimethylolpropane acrylate (TMPA) (a product of Kyoeisha Chemical Co., Ltd.) was added as a crosslinking co-agent and a formulation of Table 2 was employed. The resultant sheet for laser processing was subjected to laser processing in the same manner as in Example 1, to obtain a flexographic printing plate (Example 2). The resultant flexographic printing plate was subjected to the same evaluation and measurement as in Example 1. The results are shown in Table 2.

### Examples 3 to 5

Sheets for laser processing, having a base material layer laminated were obtained in the same manner as in Example 1 except that formulations of Table 2 were employed. The resultant sheets for laser processing were subjected to laser processing in the same manner as in Example 1, to obtain flexographic printing plates (Examples 3 to 5). The resultant flexographic printing plates were subjected to the same evaluation and measurement as in Example 1. The results are shown in Table 2.

### Comparative Example 1

A sheet for laser processing was constituted using the (a-2) alone. It was laminated with a base material layer without being irradiated with an electron beam, to obtain a sheet for laser processing, of laminate type. The resultant sheet for laser processing was subjected to laser processing in the same manner as in Example 1, to obtain a flexographic printing plate (Examples 3-5). The flexographic printing plate was subjected to the same evaluation and measurement as in Example 1. The results are shown in Table 2.

TABLE 2

| | Ex. | Ex. | Ex. | Ex. | Ex. | Comp. |
|---|---|---|---|---|---|---|
| | 1 | 2 | 3 | 4 | 5 | Ex. 1 |
| (A1) | | | | | | |
| a-1 | 100 | | | 50 | 100 | |
| a-2 | | 100 | | 50 | | 100 |
| a-3 | | | 100 | | | |
| (A2) | | | | | | |
| b-1 | | | | | 50 | |
| Silica (AEROSIL R972) | 40 | 40 | 40 | 40 | 40 | |
| Silane coupling agent | 1 | 1 | 1 | 1 | 1 | |
| (TSL 8370) | | | | | | |
| Crosslinking co-agent | | 1.5 | 1.5 | | | |
| (TMPA) | | | | | | |
| Lubricant (stearylamine) | 2 | 1 | 1 | 1 | 2 | |
| Electron beam exposure | 20 | 20 | 20 | 20 | 20 | 0 |
| (Mrad) | | | | | | |
| Toluene gel content (%) | 99 | 90 | 89 | 96 | 88 | 0 |
| Evaluation of laser | | | | | | |
| processing (speed: 30%) | | | | | | |
| Flaming | ◯ | ◯ | ◯ | ◯ | ◯ | X |
| Odor | ◯ | ◯ | ◯ | ◯ | ◯ | ◯ |
| Stickiness | ◯ | ◯ | ◯ | ◯ | ◯ | X |
| Engravability | ◯ | ◯ | ◯ | ◯ | ◯ | X |

### Examples 6, 7 and Comparative Examples 2, 3

Sheets for laser processing, having a base material layer laminated were obtained in the same manner as in Example 1 except that formulations of Table 3 were employed. The resultant sheets for laser processing were subjected to laser processing in the same manner as in Example 1, to obtain flexographic printing plates (Examples 6 and 7 and Comparative Examples 2 and 3). The resultant flexographic printing plates were subjected to the same evaluation and measurement as in Example 1. The results are shown in Table 3. Incidentally, MFR was measured according to “melt flow rate (MFR) (2)” shown below.

[Melt Flow Rate (MFR) (2)]

Measurement was made under the conditions of 150° C. and 2.16 kg according to JIS K 7210. A larger MFR indicates superior moldability.

TABLE 3

| | | | Comp. Ex. | Comp. Ex. |
|---|---|---|---|---|
| | Ex. 6 | Ex. 7 | 2 | 3 |
| (A1) | | | | |
| a-1 | 75 | 50 | | |
| a-4 | 25 | 50 | 100 | 100 |
| (A2) | | | | |
| b-1 | 50 | 50 | | |
| Silica (AEROSIL R972) | 20 | 20 | | 20 |
| Silane coupling agent (TSL8370) | 1 | 1 | | 1 |
| Lubricant (sorbitan stearate) | 3 | 3 | 0.5 | 1 |
| Electron beam exposure (Mrad) | 20 | 20 | 20 | 20 |
| Hardness | 48 | 52 | 33 | 55 |
| Toluene gel content (%) | 82 | 72 | — | — |
| MFR (g/10 min) | 12 | 8.8 | <0.5 | <0.5 |
| Evaluation of laser processing | | | | |
| (speed: 30%) | | | | |
| Flaming | ◯ | ◯ | ◯ | ◯ |
| Odor | ◯ | ◯ | ◯ | ◯ |
| Stickiness | ◯ | ◯ | X | X |
| Engravability | ◯ | ◯ | ◯ | ◯ |

### Examples 8 to 10

Sheets for laser processing, having a base material layer laminated were obtained in the same manner as in Example 1 except that formulations of Table 4 were employed. The resultant sheets for laser processing were subjected to laser processing in the same manner as in Example 1, to obtain flexographic printing plates (Examples 8 to 10). The resultant flexographic printing plates were subjected to the same evaluation and measurement as in Example 1. The results are shown in Table 4. Incidentally, MFR was measured according to the “melt flow rate (MFR) (2)” described above. The results of the evaluation and measurement of Comparative Example 2, shown in Table 3 are also shown in Table 4, for comparison.

TABLE 4

| | | | | Comp. |
|---|---|---|---|---|
| | Ex. 8 | Ex. 9 | Ex. 10 | Ex. 2 |
| (A1) | | | | |
| a-1 | 75 | 75 | 75 | |
| a-4 | 25 | 25 | 25 | 100 |
| (A2) | | | | |
| b-2 | 30 | | | |
| b-3 | | 50 | | |
| b-4 | | | 30 | |
| Silica (AEROSIL R972) | 20 | 20 | 20 | |
| Silane coupling agent (TSL8370) | 1 | 1 | 1 | |
| Lubricant (sorbitan stearate) | 3 | 4 | 1 | 0.5 |
| Electron beam exposure (Mrad) | 20 | 20 | 20 | 20 |
| Hardness | 58 | 50 | 52 | 33 |
| Toluene gel content (%) | 75 | 80 | 70 | — |
| MFR (g/10 min) | 6.0 | 8.2 | 7.1 | <0.5 |
| Evaluation of laser processing | | | | |
| (speed: 30%) | | | | |
| Flaming | ◯ | ◯ | ◯ | ◯ |
| Odor | ◯ | ◯ | ◯ | ◯ |
| Stickiness | ◯ | ◯ | ◯ | X |
| Engravability | ◯ | ◯ | ◯ | ◯ |

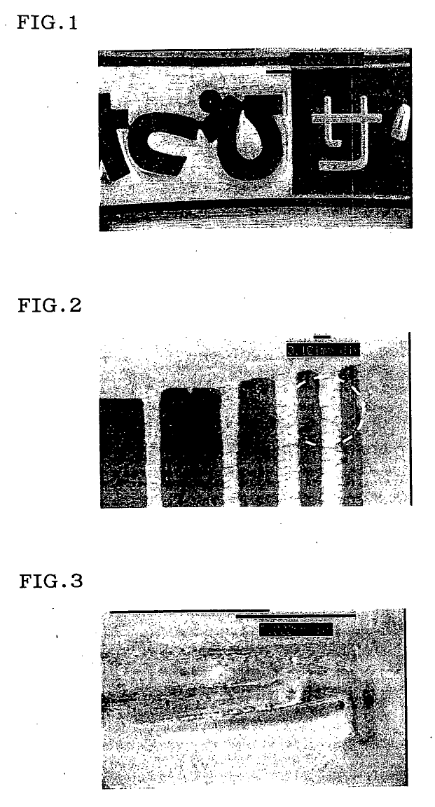

As shown in Table 2, all of the sheets for laser processing, constituting the flexographic printing plates of Examples 1 to 5 had a high toluene gel content, was low in flaming, odor and stickiness, and showed good engravability. In FIG. 1 and FIG. 2 are shown the microphotographs of the flexographic printing plate of Example 1. Incidentally, the scale is indicated therein (in photograph). It is clear from FIG. 1 that even the fine portion of letter (e.g. the center of the symbol (°) attached to Hiragana character “Pi” which is reversed) is engraved. It is also clear from FIG. 2 that the line portion of 0.1 mm in width (see the inside of white-broken-line circle) is engraved well. Meanwhile, in the sheet for laser processing, constituting the flexographic printing plate of Comparative Example 1, the toluene gel content was 0%, the flaming was big and the stickiness was sever although the odor was low, and the laser-non-irradiated portion was molten. The microphotograph of the flexographic printing plate of Comparative Example 1 is shown in FIG. 3, for reference.

As shown in Table 3, both of the flexographic printing plates of Examples 6 and 7 was low in hardness, high in MFR (which is an alternative characteristic for moldability), and good in laser processability. Meanwhile, both of the flexographic printing plates of Comparative Examples 2 and 3 was good in engravability but was low in hardness and severe in stickiness.

Furthermore, as is clear from Table 4, the flexographic printing plates of Examples 8 to 10 were good in laser processability and, as compared with the flexographic printing plate of Comparative Example 2, were low in stickiness.

The flexographic printing plate of the present invention is suitable mainly as a printing plate for letterpress printing.

1. A flexographic printing plate, comprising:
a plate formed from a sheet, the sheet comprising a composition comprising 100 parts by mass of a thermoplastic elastomer (A1) and 0.1 to 50 parts by mass of silica particles (B);
wherein the plate comprises an intended printing pattern on at least one side, the intended printing pattern being formed by engraving the sheet by laser processing.

2. The flexographic printing plate according to claim 1, wherein the composition further comprises 100 parts by mass or less of a non-crosslinked rubber (A2) relative to 100 parts by mass of the thermoplastic elastomer (A1).

3. The flexographic printing plate according to claim 2, wherein the non-crosslinked rubber (A2) is a liquid butadiene rubber.

4. The flexographic printing plate according to claim 1, wherein the thermoplastic elastomer (A1) comprises at least one member selected from the group consisting of a syndiotactic 1,2-polybutadiene, a hydrogenated diene-based copolymer and a styrene-based thermoplastic elastomer.

5. The flexographic printing plate according to claim 4, wherein:
the thermoplastic elastomer (A1) comprises a syndiotactic 1,2-polybutadiene and a styrene-based thermoplastic elastomer; and
mass ratio of the syndiotactic 1,2-polybutadiene to the styrene-based thermoplastic elastomer is from 80:20 to 20:80.

6. The flexographic printing plate according to claim 1, wherein the silica particles (B) are anhydrous silica particles.

7. The flexographic printing plate according to claim 1, wherein the silica particles (B) have an average primary particle diameter of at least 0.005 μm or and less than 0.1 μm.

8. The flexographic printing plate according to claim 1, wherein the sheet has been subjected to a crosslinking treatment.

9. The flexographic printing plate according to claim 8, wherein the sheet has a gel proportion of at least 80 mass % or more, when extracted with toluene of 60° C. for 3 hours.

10. The flexographic printing plate according to claim 1, wherein the sheet comprises a sheet-shaped base material layer laminated on a side other than the at least one side on which the intended printing pattern is formed.

11. A method for producing a flexographic printing plate, comprising:
forming a sheet from a composition comprising 100 parts by mass of a thermoplastic elastomer (A1) and 0.1 to 50 parts by mass of silica particles (B); and
engraving the sheet by laser processing to form an intended printing pattern on at least one side of the sheet.

12. The method for producing a flexographic printing plate according to claim 11, wherein the composition further comprises 100 parts by mass or less of a non-crosslinked rubber (A2) relative to 100 parts by mass of the thermoplastic elastomer (A1).

13. The method for producing a flexographic printing plate according to claim 12, wherein the non-crosslinked rubber (A2) is a liquid butadiene rubber.

14. The method for producing a flexographic printing plate according to claim 11, wherein the thermoplastic elastomer (A1) is at least one member selected from the group consisting of a syndiotactic 1,2-polybutadiene, a hydrogenated diene-based copolymer and a styrene-based thermoplastic elastomer.

15. The method for producing a flexographic printing plate according to claim 14, wherein:
the thermoplastic elastomer (A1) comprises a syndiotactic 1,2-polybutadiene and a styrene-based thermoplastic elastomer; and
a mass ratio of the syndiotactic 1,2-polybutadiene to the styrene-based thermoplastic elastomer is from 80:20 to 20:80.

16. The method for producing a flexographic printing plate according to claim 11, wherein the silica particles (B) are anhydrous silica particles.

17. The method for producing a flexographic printing plate according to claim 11, wherein the silica particles (B) have an average primary particle diameter of at least 0.005 μm and less than 0.1 μm.

18. The method for producing a flexographic printing plate according to claim 11, wherein the sheet has been subjected to a crosslinking treatment.

19. The method for producing a flexographic printing plate according to claim 18, wherein the sheet has a gel proportion of at least 80 mass %, when extracted with toluene of 60° C. for 3 hours.

20. The method for producing a flexographic printing plate according to claim 11, wherein the sheet comprises a sheet-shaped base material layer laminated on a side other than the at least one side on which the intended printing pattern is formed.
